(19) United States
(12) Patent Application Publication
(10) Pub. No.: US 2006/0128567 A1
(43) Pub. Date: Jun. 15, 2006

(54) Imaging member having plasticizer containment layer

(75) Inventors: Cheryl J. Brickey, Webster, NY (US); Robert P. Bourdelais, Pittsford, NY (US); John M. Palmeri, Hamlin, NY (US); Scott A. Dony, Hamlin, NY (US)

Correspondence Address: Paul A. Leipold;Paten Legal Staff, Eastman Kodak Company, 343 State Street, Rochester, NY, 14650-2201, US

(73) Assignee: Eastman Kodak Company

(21) Appl. No.: 11/011,731

(22) Filed: Dec. 14, 2004

(51) Int. Cl. B41M 5/035

(52) U.S. Cl. 503/227

(57) ABSTRACT

The invention relates to an imaging member comprising a dye receiving layer, a plasticized polymer layer, and a plasticizer containment layer, wherein the plasticizer is present in an amount greater than 5% of said plasticized polymer layer.

### FIELD OF THE INVENTION

This invention relates to elements used in thermal dye transfer, and more particularly to a plasticizer containment layer for thermal dye transfer printing of substrates that contain plasticizer materials.

### BACKGROUND OF THE INVENTION

Vinyl thin films have historically been utilized in application that require resistance to heat, electrical insulating, low temperatures and applications requiring flexibility of an extended period of time. In addition, vinyl thin films are soft, flexible and are easily embossed by heat and pressure. Typical applications for vinyl thin films include heatproof electrical wires, interior surfaces for automobiles and packaging.

Like all plastic materials, vinyl results from a series of processing steps that convert hydrocarbon-based raw materials (petroleum, natural gas or coal) into unique synthetic products called polymers. The vinyl polymer is unusual, however, because it is based only in part on hydrocarbon feedstocks. Generally, the other half of the vinyl polymer is based on the natural element chlorine. Chlorine gives vinyl two advantages. First, chlorine is derived from brine, which is a solution of common salt and water, and a readily available, inexpensive commodity. Thus, vinyl is less sensitive to fluctuations in the world oil market than are totally oil dependent polymers. Second, chlorine has excellent inherent flame retardant properties. These properties are passed on directly to vinyl products, making vinyl an excellent choice for applications such as electrical conduit and wiring that require high resistance to ignition and flame spread.

Through a chemical reaction, ethylene and chlorine combine to form ethylene dichloride which, in turn, is transformed into a gas called vinyl chloride monomer (VCM). A final step, called “polymerization,” converts the monomer into vinyl polymer, a fine-grained, white powder or resin known as polyvinyl chloride (PVC), or simply “vinyl.”

Vinyl resin, however, is still one step away from being a usable material: it must be combined with selected chemical additives and modifiers to achieve the various properties desired in vinyl products. Flexible vinyl or PVC is a cured mixture of hard PVC resin, plasticizers and other additives, which provide processing, and performance characteristics. Plasticizer is an organic ester compound made by heating acids and alcohol in the presence of a catalyst. It makes plastics flexible without sacrificing strength or durability. Plasticizer has superior properties in plasticity by adding it to a polymer, improving its processing ability, and changing its physical properties. It is used to enforce the flexibility of synthetic leather, sheets, polyvinyl chloride (PVC) films and coated wires. The vinyl resin and plasticizer are not chemically bound, but held together by strong electromotive forces as a solid solution. Vinyl plasticizer, over a period of time, is capable of being removed from the surface of a vinyl film, and is typically replaced by material from the vinyl mass in the core of the vinyl film. The mechanism by which the plasticizer moves from the mass to the surface of the film is called diffusion.

Phthalates are the most commonly used plasticizers to make thin PVC soft and flexible. Representative examples of plasticizers in the phthalic acid group include is di(2-ethylhexyl) phthalate, commonly known as DEHP or DOP. More DEHP is employed worldwide than any other plasticizer, and it is the most widely used plasticizer for PVC medical devices, in which it conveys critical processing advantages, trioctyltrimellitate (TOTM), citrates, and adipates.

U.S. RE36,519 discloses the use of polymer plasticizers to improve thermal dye transfer efficiency, reduce sensitometric changes upon storage and to reduce dye crystallization in dye donor elements.

U.S. Pat. No. 6,291,396 discloses an aliphatic ester plasticizer containing in a dye receiving layer. Plasticizer from about 10 to 20% weight percent contained in the dye receiving layer improved thermal dye transfer uptake and thermal dye density in imaged areas.

U.S. Pat. No. 5,688,081 discloses a transferable protection layer for thermal dye transfer images. As noted in U.S. Pat. No. 5,688,081, the protection layer provides the thermal image protection from fingerprints, spills and plasticizer from film album pages or sleeves made from poly(vinyl chloride).

### PROBLEM TO BE SOLVED BY THE INVENTION

There is a need for a plasticizer containment layer, which will significantly reduce both the diffusion of plasticizer from imaging substrates into imaging receiving layers and significantly reduce the migration of imaging dyes into imaging substrates that contain plasticizer.

### SUMMARY OF THE INVENTION

It is an object of the invention to provide a plasticizer containment layer that significantly reduces plasticizer diffusion into dye receiver layers.

It is another object to provide a plasticizer containment layer that prevents imaging dye migration into substrates that contain plasticizer.

It is a further object to provide a dye receiver element for the dye printing of images that will give good uptake of the dye.

These and other objects of the invention are accomplished by an imaging member comprising a dye receiving layer, a plasticized polymer layer, and a plasticizer containment layer, wherein the plasticizer is present in an amount greater than 5% of said plasticized polymer layer.

### ADVANTAGEOUS EFFECT OF THE INVENTION

The invention provides a plasticizer containment layer capable of reducing plasticizer migration into the dye receiving layers and capable of reducing dye migration into substrates containing plasticizer. In one preferred embodiment, the invention provides a dye printed vinyl substrate used for wall decoration.

### DETAILED DESCRIPTION OF THE INVENTION

The invention has numerous advantages over prior practices in the art. The invention provides a plasticizer containment layer capable of reducing both plasticizer migration into dye receiving layers and capable of reducing dye migration into substrates that contain plasticizer. Prior art dye imaging systems typically avoid the use of plasticized substrates such as vinyl because of both the plasticizer diffusion and dye migration into the plasticizer. Both plasticizer diffusion and dye migration into plasticized substrates significantly reduces printed image quality. The use of substrates or over-lamination materials that contain plasticizer have significant commercial value in that the substrates or over-lamination materials are very flexible compared to prior art substrates, particularly at low temperatures, are electrically insulating and are easily embossed by heat and pressure.

In one embodiment of the invention, dye printed substrates containing plasticizer are utilized for wall decorations. Vinyl image substrates containing 40% by weight of plasticizer printed by thermal dye transfer are utilized for wall boarders. The plasticized vinyl substrate allow for ease of application compared to other polymer substrates such as polyester. Further, during removal of the vinyl wall boarder, the thermal printed vinyl substrate does not fracture. Finally, because the vinyl substrate can easily be embossed, the thermal printed wall boarder can be embossed with several different patterns which will de-gloss the image allowing for a wider viewing angle.

Recently there has been a trend in the marketing of mass consumer items to try to localize the marketing to separately approach smaller groups. These groups may be regional, ethnic, gender, age, or special interest differentiated. In order to approach these different groups, there is a need to provide packaging that is specifically directed to these groups. Traditional printing of packaging materials are generally suited for very long runs of material and to form shorter runs or to provide rapid changes in packaging is impossible or very expensive. We have found thermal dye transfer materials that are suitable for packaging uses. Further, recently there has become available rapid thermal dye transfer apparatus suitable for short runs of material. The combination of a low cost label material with the processing apparatus available for rapid short and long runs of material has resulted in the opportunity for thermal dye transfer material to be utilized as labels in packaging materials, in particular label that utilize vinyl substrates. Thermal dye transfer materials that have properties such as flexibility, low cost, and the ability to flex and bend has resulted in materials satisfactory and suitable for packaging. By combining the advantages of thermal dye transfer printing, mainly excellent image quality, short run economics and ability to print from a digital file, thermal dye transfer labels provides a digital printing solution to label printers.

The ability to control or pattern the plasticizer containment layer provides for controlled or selective migration of plasticizer into an image layer of auxiliary polymer. The controlled or selective migration allows the creation of product labels that change color or whose image quality is significantly degraded over expose to time and/or temperature. Further, selective migration of plasticizer into an auxiliary polymer layer can alter the optical properties of the auxiliary polymer layer allowing for thin, flexible polymer optical films which can alter the properties of transmitted light for use in display devises such as LCD or OLED devices. These and other advantages will be apparent from the detailed description below.

The terms as used herein, “top”, “upper”, “image side”, and “face” mean the side or toward the side of a dye image receiver sheet bearing the dye-receiving imaging layers. The terms “bottom”, “lower side”, and “back” mean the side or toward the side of the dye image receiver sheet opposite from the side bearing the dye imaging layers. The term used herein “peelable adhesive” or “repositionable adhesive” means adhesive materials that have a peel strength less than 100 grams/cm. The term used herein “permanent adhesive” means adhesive materials that have a peel strength of greater than 100 grams/cm. The term used herein “substrate” means materials that are commonly utilized in the advertising and display industry for the lamination of images. Examples include acrylic sheets, paperboard, wallboard, fabric, cardboard and polymer sheets.

The terms “planar birefringence” and “birefringence” as used herein is the difference between the average refractive index in the film plane and the refractive index in the thickness direction. That is, the refractive index in the machine direction and the transverse direction are totaled, divided by two and then the refractive index in the thickness direction is subtracted from this value to yield the value of the planar birefringence. Refractive indices are measured using an Abbe-3L refractometer using the procedure set forth in Encyclopedia of Polymer Science & Engineering, Wiley, N.Y., 1988, pg. 261. The term “low birefringence” means a material that produces small changes in the polarization state of light and is confined to polymer web material that has a birefringence less than 0.05.

The term used herein “dye donor element sticking” means the tendency of dye donor elements, which typically are thermal dyes coated onto thin oriented polymer, to stick to the dye receiver element. Dye donor element sticking is typically measured by printing high density color patches and making visual observations of the dye donor element sticking to the receiving layer. At the onset of sticking, vertical density lines, sometimes referred to as chatter, are observed down the printed page at a repeatable frequency. As used herein, the term “dye uptake” means the ability of any dye-receiving layer to accept dyes that are printed or thermally transferred. Dye uptake is typically related to the thermal printing temperature, chemistry of the dye-receiving layer, and chemistry of the dyes and the Tg of the dye-receiving layer. As used herein, the term “dye migration” means the tendency of the dyes to move in the dye-receiving layer after printing. Dyes that have a high amount of migration will result in an image becoming fuzzy, less sharp or text becoming fuzzy or the inability of bar code reading equipment to read printed black bar codes. Dye migration is typically related to ambient temperature, dye-receiving layer chemistry, Tg of the dye-receiving layer and amount of plasticizer in the dye-receiving layer.

In order to provide an imaging member containing a plasticized polymer layer, the use of a plasticizer containment layer is preferred. Plasticized polymer layers offer advantages of being conformable, being a good electrical insulator and able to be easily bent in temperatures less than 0 degrees C. By providing a plasticizer containing layer between the imaging layers and the plasticized polymer layer, problems with the plasticizer reducing the quality or the lifetime of the image are improved. It is understood there is a relationship between the diffusivity of the containment layer and molecular weight of the plasticizer. As the molecular weight of the plasticizer decreases, the mobility of the plasticizer increases, thus requiring a containment layer with a low diffusivity.

The plasticized polymer preferable comprises polyvinyl chloride. Polyvinyl chloride has been shown to be a useful polymer for both industrial and imaging applications. Polyvinyl chloride provides many of the desired engineering properties such as electrical insulation and easy of bending particularly at low temperatures. Further polyvinyl chloride is wide available and produced in economic quantities.

The polyester containment layer functions as a layer that reduces unwanted plasticizer migration into the imaging layer. Plasticizer migration into dye formed image layers significantly reduces the quality and commercial value of dye based images. In preferred embodiment of the invention, the plasticizer containment layer preferable comprises at least one member selected from the group consisting essentially of polyesters, polycarbonates, and olefins. These thermoplastic materials have been shown to provide an excellent barrier between imaging layers of the invention and polymer plasticizer. Further, these materials, being thermoplastics capable of being melt extruded, can be applied to the surface of the plasticized polymer layer utilizing melt extrusion from a slit die. It has been found the during melt extrusion, some orientation of the polymer occurs further enhancing the melt extruded polymers ability to provide a plasticizer barrier. Depending on the melt extrusion process conditions, particularly draw ratio and extrusion, increases in barrier properties as much as 10-20% have been measured. Both the polyester and polycarbonate polymers can be solvent coated onto the plasticized polymer layer utilizing known coating techniques such as roll or hopper coating. Solvent coated polyester and polycarbonate coatings have been shown to be very uniform and thin, typical between 0.8 and 20 micrometers.

In another preferred embodiment of the invention, the plasticizer containment layer comprises a metallic layer. Metallic layers have been shown to provide an excellent barrier to plasticizer as well as oxygen and moisture. Metals such as nickel, aluminum, silver provides excellent plasticizer barrier properties. During the application of metal to the plasticized layer, pinholes or incomplete metallization often occurs resulting in small areas that could allow for plasticizer migration. To reduce the occurrence of metallic pinholes, it has been found that a second layer of metal is required. It has also been found that as little as 300 angstroms of metal applied to the plasticized polymer layer provides sufficient plasticizer containment. To avoid the resulting specular reflection from the metal containment layer, additional layers may be required such as a polymer layer containing TiO₂. In a preferred embodiment of the invention, Indium tin oxide (ITO) is a preferred metallic containment layer because it provides both barrier properties and is substantially transparent avoiding the need for a layer to reduce the specular reflectivity of an opaque metallic layer. Further, ITO has excellent electrical conductivity reducing unwanted static charge that occurs during web transport.

In further embodiment of the invention, the plasticizer containment layer comprises a UV cured polyacrylate. UV cured polyacrylates have been shown to provide an excellent plasticizer barrier and can easily be applied to the surface of a plasticized polymer layer. The process of ultraviolet or UV curing is defined as hardening of a liquid film of material when exposed to ultraviolet light. The particular substance to be processed may vary widely depending upon its application and final use, but basically is composed of base polymers, non-solvent diluents and photoinitiators. UV curable materials to be cured by exposure to UV energy are specially formulated to polymerize in a certain way. Preferred UV cure polymer systems that provide a plasticizer barrier are cycloaliphatic epoxide, partially acrylated bisphenol-A epoxy resin, acrylates, methacrylates, and maleates.

The plasticizer containment layer preferably has a plasticizer transmission of less than 0.1 grams per m² per 24 hours. A plasticizer transmission of less than 0.1 grams per m² per 24 hours has been shown to not significantly degrade the image quality of the thermal dye transfer printed image over a period of several years. Plasticizer transmission is measured at 1 atmosphere pressure, at 24 degrees C. and at 50% RH.

In one embodiment of the invention, the plasticizer containment layer is applied to the plasticized polymer layer in a pattern. Application of the plasticizer containment layer in a pattern allows for controlled patterned-wise diffusion of plasticizer into the image layer creating a time dependant change of image content and image quality. An application example would be food expiration labels were a thermal dye transfer image of a bottle of milk would change and alert a customer of expired milk. Another example of utilization of a pattern-wise application of a plasticizer containing layer would be a security badge were authenticity could be verified by visual examination of the plasticizer migration pattern in both the image layer and sub-image layers. Useful patterns include text, geometric patterns, graphic and images. Further, since plasticizer migration can depend upon the thickness of a polymer plasticizer containment layer, polyolefin layer for example, a plasticizer gradient, created by changing the thickness of the plasticizer containment layer can be created.

The application of the plasticizer containment layer to the plasticized polymer layer can be accomplished by UV polymer coating, melt extrusion coating of thermoplastic containment layers, gravure printing, ink jet printing or known solution coating techniques such as curtain coating or blade coating.

The plasticizer containment layer preferably comprises a lubricant. Lubricants are preferred as they provide the required slip characteristics for contact printing methods such as thermal dye transfer printing of the imaging layers of the invention. It has been found that plasticizer addition to polymer increases the coefficient of friction between dye donor elements and the plasticized polymer layer causing unacceptable image quality defects and thermal printer dye donor transport problems. More preferably, the lubricant addition to the plasticizer containment layer is between 0.5 and 5% by weight of polymer in the plasticizer containment layer. Lubricant addition less than 0.25% does not significantly improve dye donor slip for thermal dye transfer printing. Lubricant addition above 3.5 weight % has been shown to reduce adhesion of the containment layer and the plasticizer layer.

The plasticizer containment layer preferably has a surface energy of between 32 and 45 dynes per square centimeter. This surface energy range provides good performance for thermal dye transfer printing while allowing for good image layer adhesion to the plasticizer containment layer.

In another embodiment of the invention, the imaging member preferably comprises a pressure sensitive adhesive and carrier sheet wherein the pressure sensitive adhesive is adjacent said plasticized polymer layer. An example of an imaging member containing a pressure sensitive adhesive is as follows:

Dye receiver layer
Plasticizer containment layer
Polymer layer containing plasticizer
Pressure sensitive adhesive

Pressure sensitive adhesives allow the invention materials to be utilized, for example, as a pressure sensitive label, wall decoration material or automobile graphics material. Suitable pressure sensitive adhesives may be inorganic or organic, natural or synthetic, which is capable of bonding the image to the desired surface-by-surface attachment. Examples of inorganic pressure sensitive adhesives are soluble silicates, ceramic and thermosetting powdered glass. Organic pressure sensitive adhesives may be natural or synthetic. Examples of natural organic pressure sensitive adhesives include bone glue, soybean starch cellulosics, rubber latex, gums, terpene, mucilages and hydrocarbon resins. Examples of synthetic organic pressure sensitive adhesives include elastomer solvents, polysulfide sealants, theromplastic resins such as isobutylene and polyvinyl acetate, theromsetting resins such as epoxy, phenoformaldehyde, polyvinyl butyral and cyanoacrylates and silicone polymers.

For single or multiple layer pressure sensitive adhesive systems, the preferred pressure sensitive adhesive composition is selected from the group consisting of natural rubber, syntheic rubber, acrylics, acrylic copolymers, vinyl polymers, vinyl acetate-, urethane, acrylate-type materials, copolymer mixtures of vinyl chloride-vinyl acetate, polyvinylidene, vinyl acetate-acrylic acid copolymers, styrene butadiene, carboxylated stryrene butadiene copolymers, ethylene copolymers, polyvinyl alcohol, polyesters and copolymers, cellulosic and modified cellulosic, starch and modified starch compounds, epoxies, polyisocyanate, polyimides.

In addition to the plasticizer containment layer being applied by pattern-wise or uniformly coating the surface of the plasticized polymer layer, preferably the plasticizer containment layer is applied to the surface of the plasticized polymer layer utilizing thermal transfer. Thermal transfer of the plasticizer containment layer allows for printing of both the plasticizer containment layer and a dye-receiving layer for further printing of graphics, text or images. In order to provide a thermal transfer printed plasticizer containment layer a containment donor element is preferred. The preferred containment donor element comprises in order a plasticizer containment layer; a dye receiving layer, an oriented polymer sheet, and a lubricant layer is preferred. The containment donor element of the invention allows for thermal printing of a plasticized polymer layer with both a containment layer and a dye receiving layer for subsequent printing of graphics, test and images, eliminating the need for an expensive dye receiver layer coating manufacturing step. An example of a containment donor element is as follows:

Plasticizer containment layer
Dye receiver layer
Oriented polymer sheet

During thermal transfer of the plasticizer containment layer and the dye receiving layer, the bond between the dye receiving layer and the oriented polymer sheet is broken allowing in order, the plasticizer containment layer and the dye receiving layer to be transferred to the surface of the plasticized polymer layer. Further, because both the plasticizer containment layer and the dye receiving layer can be printed pattern-wise utilizing a thermal transfer printer, both the containment layer and the dye receiving layer will be in registration allowing for further desirable complexity to be incorporated into the image.

The oriented polymer sheet of the containment donor element preferable has a thickness of between 6 and 25 micrometers. Below 4 micrometers web transport of the donor element is difficult. Above 35 micrometers, the heat transfer to the interface between the dye receiving layer and the oriented polymer layer is not sufficient to create a heated separation. The oriented polymer sheet may be provided with slip layers known in the art to facilitate the transfer of the dye receiving layer from the oriented polymer sheet or used to reduce friction between the thermal transfer print head and the oriented polymer sheet.

The dye receiving layer used in the containment donor element preferably comprises a cross linked copolymer of polyester and polyurethane. The polyester component of the copolymer provides excellent uptake of imaging dye and excellent imaging dye retention. The polyurethane component of the copolymer provides lubrication to resist sticking of dye donor web materials at the pressures and temperatures common during thermal dye transfer. Since the polyester component provides the dye uptake and retention properties, the polyester component of the copolymer preferably is the majority component. Polyester component below 70% by weight of copolymer, the dye uptake and dye retention are reduced to an unacceptably low level, reducing the quality of the printed image. Above, 99.5% by weight of copolymer, little lubrication is provided to thermal dye transfer donor webs, significantly increasing donor web sticking to the receiving layer. A cross-linked copolymer of polyester and polyurethane polymer is preferred because cross-linking the copolymer of the invention improves web adhesion, aids in coating and subsequent drying of the coated dye-receiving layer and improves the mechanical properties of the coated, dried dye-receiving layer.

The polyester-based polyurethane polymer for the dye receiving layer may be made from a variety of polyester polyols and polyisocyanates. When made from difunctional polyester polyols (2 hydroxyl groups per polyester polyol molecule) and diisocyanates, the polymer is typically made by preparing a prepolymer at a stoichiometric ratio of isocyanate groups to hydroxyl groups (NCO/OH ratio) of greater than one, preferably in the range of from 1.3 to 3.0 and optimally in the range of from 1.5 to 2.7. Mixtures of polyols and mixtures of polyisocyanates may be used and it is possible to include other polyfunctional reactive nucleophiles, and also polyols and/or polyisocyanates with functionalities greater than 2. If polyols or polyisocyanates of functionality different than 2 are employed it is especially necessary to control the amounts of reactants having functionality different than 2 and to adjust NCO/OH so as to avoid either excessive chain termination or extensive network formation that could lead to gelation of the pre-polymer.

To aid in dispersibility in water, groups that are hydrophilic, or that can be converted to hydrophilic groups, are customarily chemically incorporated into the pre-polymer. Typical of hydrophilic groups are backbone constituents with pendant polyethylene oxide chains. These act as nonionic stabilizing groups. Commonly used to create anionic stabilizing groups are carboxylic acid or sulfonic acid groups that hang off the prepolymer backbone. These become hydrophilic after salting them with tertiary amines, or the inverse can be done, where backbone or pendant tertiary amino groups can be salted with acids, giving rise to cationic stabilization. However made, the prepolymeric, isocyanate-terminated intermediate is typically dispersed in water or water containing one or more surfactants and right after dispersion is chain extended by reaction of remaining, unreacted isocyanate groups with polyfuctional nucleophiles. When salting is used for stabilization, the prepolymer can be salted before it is dispersed, or the salting amine or acid as the case may be can be placed in the water phase before dispersion. Chain extension increases molecular weight and affords an aqueous dispersion of a polymeric urethane. The chain extender is a di or polyfunctional reactive nucleophile that reacts with unreacted isocyanate groups. Chain extender to unreacted isocyanate group stoichiometry is usually chosen to maximize molecular weight of the polyurethane. The reactive nucleophilic groups in the chain extender can be amino (including hydrazine), hydroxyl, or other reactive groups. Even water can function as a chain extender. Mixtures of chain extenders, or chain extenders with more than one kind of reactive nucleophilic group, for example, an aminoalcohol, can be used.

While polyurethane has been shown to be an excellent lubricator polymer for thermal dye transfer printing of the dye receiver layer and provide a compliant layer adjacent to dye donor elements, other copolymers may be suitable to provide both good dye uptake while reducing dye donor element sticking. Other suitable polyester copolymers for thermal dye transfer printing include polycarbonate, polycyclohexylenedimethylene terephthalate and vinyl modified polyester copolymers.

The use of a plasticizer containment layer allows for the combination of plasticizer sensitive imaging dyes and plasticized polymer substrates to be used for commercial, industrial and advertising applications were a plasticized polymer has value. It is well known to utilize low birefringent polymers in optical applications such as liquid crystal display (LCD) devices, organic light emitting display (OLED) devices or polarizer sheets. Low birefringent polymers are typically cast coated from a solvent or aqueous systems to reduce stress induced unwanted birefringence into the polymer. These low birefringent polymers typically contain plasticizer materials to improve flexibility for manufacturing and assembly and to improve the lifetime of the low birefringent materials. The ability to precisely print or apply the plasticizer containment layer to a plasticized polymer layer allows for the formation of polymer thin films, which alter the properties of transmitted or reflected light energy. Polymer optical films are typically utilized in display devices such as LCD devices and OLED display devices to increase on axis brightness of display devices, diffuse incident light, increase the viewing angle of display devices, polarize light, to reflect light and to change horizontal or vertical gain of a display device.

A patterned element comprising in order a low birefringent polymer, a patterned plasticizer containment layer and transparent polymer layer is preferred. The patterned element allows for the controlled migration of plasticizer from a low birefringent polymer layer containing plasticizer to the transparent polymer layer in a pattern, selectively changing the optical properties of the transparent polymer layer to yield a desired optical feature such as transmission, absorption, reflection or change in index of refraction.

An example of an optical film utilizing controlled plasticizer migration would be a selective polarizer. Prior art polarizers utilized in LCD devices typically comprise oriented PVA located between two sheets of low birefringent polymer containing plasticizer to aid the flexibility, durability and manufacturing of the low birefringent polymer. By applying a patterned plasticizer containment layer located between the low birefringent polymer and the oriented PVA, plasticizer located in the low birefringent layer migrates into the oriented PVA layer significantly reducing the efficiency of the PVA polarizer. When a patterned polarizer is inserted into a LCD device, the areas containing the migrated plasticizer will show as a bright pattern to the viewer. Bright patterns can be selective utilized to better illuminate areas of a display such as a fuel gauge in an automobile display panel or the heart rate of a patient on a display containing patient vital signs.

Another example of controlled plasticizer migration would be the use of an interference pattern in an LCD display that would become visible after some contemplated time interval such as 100 hours. This shortened lifetime of the display could be used for critical to function display and indicate the need for replacement or for single use display that timeout after a specific time interval has passed.

The patterned element wherein the low birefringent polymer is plasticized cellulose triacetate is preferred. Cellulose triacetate or triacetylcellulose (TAC) film has traditionally been used by the photographic industry due to its unique physical properties and flame retardance. TAC film is also the preferred polymer film for use as a cover sheet for the polarizers used in liquid crystal displays. It is the preferred material for this use because of its extremely low in-plane birefringence. Its out of plane birefringence is also small (but not zero), and is useful in providing some optical compensation to the LCD allowing for the increase in LCD image quality.

Intrinsic birefringence of polymers describes the fundamental orientation of a material at a molecular level. It is directly related to the molecular structure (bond angles, rotational freedom, presence of aromatic groups, etc.) of the material. The intrinsic birefringence is not affected by process conditions (temperature, stresses, pressures) used to make a macroscopic object. Crystalline and liquid crystalline polymer materials have the convenient property that their intrinsic birefringence manifests itself almost perfectly when they are assembled into a macroscopic article. Layers of crystalline and liquid crystalline molecules often can be manufactured such that all the molecules in the article are in registry with each other and thus preserve their fundamental orientation. Their intrinsic birefringence can be highly modified by the manufacturing process. Thus, the measured birefringence of an actual article will be a resultant of its intrinsic birefringence and the manufacturing process. Because we are dealing with such amorphous polymeric materials, the following definitions refer to this measured birefringence and not intrinsic birefringence.

A plasticizer can be added to the cellulose acetate film to improve the mechanical strength of the film. The plasticizer has another function of shortening the time for the drying process. Phosphoric esters and carboxylic esters (such as phthalic esters and citric esters) are preferred TAC plasticizer. Examples of the phosphoric esters include triphenyl phosphate (TPP) and tricresyl phosphate (TCP). Examples of the phthalic esters include dimethyl phthalate (DMP), diethyl phthalate (DEP), dibutyl phthalate (DBP), dioctyl phthalate (DOP), diphenyl phthalate (DPP) and diethylhexyl phthalate (DEHP). Examples of the citric esters include o-acetyltriethyl citrate (OACTE) and o-acetyltributyl citrate (OACTB).

The barrier layer for the low birefringent polymer suitable for a patterned LCD polarizer preferably comprises a polymer having little or no out-of-plane birefringence that is water soluble or water dispersible. Water soluble polymers suitable for use in the barrier layer of the invention include polyvinyl alcohols and copolymers thereof, gelatin, gelatin derivatives, casein, agar, sodium alginate, starch, acrylic acid containing polymers, maleic anhydride containing polymers, hydrophilic cellulose esters such as carboxymethylcellulose, hydroxypropyl methyl cellulose, and polyacrylamides. Suitable water dispersible polymers include polyesters, particularly polyesterionomers, polyurethanes, and latex polymers having hydrophilic functionality such as (meth)acrylic acid containing polymers, maleic anhydride containing polymers, itaconic acid containing polymers, styrene sulfonic acid containing polymers, and the like.

In order to optimize both barrier properties and adhesion to contiguous layers, the barrier layer typically will contain two or more polymers. For example, the barrier layer may contain a water-soluble polymer such as gelatin and a water dispersible polymer such as a polyesterionomer. Alternatively, the barrier layer may contain two different water dispersible polymers such as a polyesterionomer and a polyurethane. The barrier layer may be crosslinked using known methods such as the addition of crosslinking agents, such at isocyanates, aldehydes, vinyl sulfone materials, aziridines and melamine resins or by exposure of the dried layer to actinic radiation.

The patterned element can be created by precision coating methods such as gravure coating or precision printing methods such as ink jet printing or thermal dye transfer printing. Cellulose triacetate has been shown to be an efficient material to print as it is flexible, thin and strong and can withstand the rigors of a roll to roll printing path in a printing device.

When thermal dye transfer printing is utilized to print the imaging member of the invention dye donor elements are utilized. Dye-donor elements that are used with the element of the invention conventionally comprise a support having thereon a dye containing layer. Any dye can be used in the dye-donor employed in the invention, provided it is transferable to the layer by the action of heat. Especially good results have been obtained with sublimable dyes. Dye donors applicable for use in the present invention are described, e.g., in U.S. Pat. Nos. 4,916,112; 4,927,803; and 5,023,228. As noted above, dye-donor elements are used to form a dye transfer image. Such a process comprises image-wise-heating a dye-donor element and transferring a dye image to an element as described above to form the dye transfer image. In a preferred embodiment of the thermal dye transfer method of printing, a dye donor element is employed which compromises a poly(ethylene terephthalate) support coated with sequential repeating areas of cyan, magenta, and yellow dye, and the dye transfer steps are sequentially performed for each color to obtain a three-color dye transfer image. When the process is only performed for a single color, then a monochrome dye transfer image is obtained.

Thermal printing heads, which can be used to transfer dye from dye-donor elements to receiving elements of the invention, are available commercially. There can be employed, for example, a Fujitsu Thermal Head (FTP-040 MCS001), a TDK Thermal Head F415 HH7-1089, or a Rohm Thermal Head KE 2008-F3. Alternatively, other known sources of energy for thermal dye transfer may be used, such as lasers as described in, for example, GB No. 2,083,726A.

A thermal dye transfer assemblage comprises (a) a dye-donor element, and (b) a element as described above, the element being in a superposed relationship with the dye-donor element so that the dye layer of the donor element is in contact with the dye image-receiving layer of the receiving element.

When a three-color image is to be obtained, the above assemblage is formed on three occasions during the time when heat is applied by the thermal printing head. After the first dye is transferred, the elements are peeled apart. A second dye-donor element (or another area of the donor element with a different dye area) is then brought in register with the element and the process repeated. The third color is obtained in the same manner.

The dye receiving layer or DRL for ink jet imaging may be applied by any known methods. Such as solvent coating, or melt extrusion coating techniques. The DRL is coated over the TL (tie layer) at a thickness ranging from 0.1-10 μm, preferably 0.5-5 μm. There are many known formulations which may be useful as dye receiving layers. The primary requirement is that the DRL is compatible with the inks, which it will be imaged so as to yield the desirable color gamut and density. As the ink drops pass through the DRL, the dyes are retained or mordanted in the DRL, while the ink solvents pass freely through the DRL and are rapidly absorbed by the TL. Additionally, the DRL formulation is preferably coated from water, exhibits adequate adhesion to the TL, and allows for easy control of the surface gloss.

For example, Misuda et al in U.S. Pat. Nos. 4,879,166; 5,264,275; 5,104,730; 4,879,166, and Japanese Patents 1,095,091; 2,276,671; 2,276,670; 4,267,180; 5,024,335; and 5,016,517 disclosesaqueous based DRL formulations comprising mixtures of psuedo-bohemite and certain water soluble resins. Light in U.S. Pat. Nos. 4,903,040; 4,930,041; 5,084,338; 5,126,194; 5,126,195; and 5,147,717 discloses aqueous-based DRL formulations comprising mixtures of vinyl pyrrolidone polymers and certain water-dispersible and/or water-soluble polyesters, along with other polymers and addenda. Butters et al in U.S. Pat. Nos. 4,857,386 and 5,102,717 disclose ink-absorbent resin layers comprising mixtures of vinyl pyrrolidone polymers and acrylic or methacrylic polymers. Sato et al in U.S. Pat. No. 5,194,317 and Higuma et al in U.S. Pat. No. 5,059,983 disclose aqueous-coatable DRL formulations based on poly (vinyl alcohol). Iqbal in U.S. Pat. No. 5,208,092 discloses water-based IRL (ink receiving layer) formulations comprising vinyl copolymers which are subsequently cross-linked. In addition to these examples, there may be other known or contemplated DRL formulations which are consistent with the aforementioned primary and secondary requirements of the DRL, all of which fall under the spirit and scope of the current invention.

The preferred DRL is a 0.1-10 micrometers DRL which is coated as an aqueous dispersion of 5 parts alumoxane and 5 parts poly (vinyl pyrrolidone). The DRL may also contain varying levels and sizes of matting agents for the purpose of controlling gloss, friction, and/or fingerprint resistance, surfactants to enhance surface uniformity and to adjust the surface tension of the dried coating, mordanting agents, antioxidants, UV absorbing compounds, light stabilizers, and the like.

Although the ink-receiving elements as described above can be successfully used to achieve the objectives of the present invention, it may be desirable to overcoat the DRL for the purpose of enhancing the durability of the imaged element. Such overcoats may be applied to the DRL either before or after the element is imaged. For example, the DRL can be over coated with an ink-permeable layer through which inks freely pass. Layers of this type are described in U.S. Pat. Nos. 4,686,118; 5,027,131; and 5,102,717. Alternatively, an overcoat may be added after the element is imaged. Any of the known laminating films and equipment may be used for this purpose. The inks used in the aforementioned imaging process are well known, and the ink formulations are often closely tied to the specific processes, i.e., continuous, piezoelectric, or thermal. Therefore, depending on the specific ink process, the inks may contain widely differing amounts and combinations of solvents, colorants, preservatives, surfactants, humectants, and the like. Inks preferred for use in combination with the image recording elements of the present invention are water-based, such as those currently sold for use in the Hewlett-Packard Desk Writer 560C printer.

However, it is intended that alternative embodiments of the image-recording elements as described above, which may be formulated for use with inks which are specific to a given ink-recording process or to a given commercial vendor, fall within the scope of the present invention.

Some embodiments of the invention may contain plasticizer containments layers that exhibit improved mechanical strength, ductility, oxygen barrier properties, moisture barrier properties, light transmission, coloration, and electrical conductivity. Further, in some embodiments of the invention, the plasticizer containment layer may contain colored pigments, nano-particles, electroluminscent pigments, residual solvents and metal particles.

The following examples illustrate the practice of this invention. They are not intended to be exhaustive of all possible variations of the invention. Parts and percentages are by weight unless otherwise indicated.

### EXAMPLES

### Example 1

In this example, an image element of the invention having a plasticizer containment layer over a vinyl substrate, was created by melt extruding polyethylene (PE) coating over a white opaque vinyl, and acrylic pressure sensitive adhesive and a composite carrier sheet containing a paper base core with rough surface layer for efficient transport though image printers. This example will show the utility of the invention materials in containing a plasticizer beneath the surface of the melt extruded PE coating over the vinyl substrate and avoid creating a conduit for dye migration away from the imaging layer to the plasticized polymer layer.

Pragmatic Sheet;

A white opaque flexible 3.5 mil vinyl polymer sheet containing 60% by weight of DEHP plasticizer that is cast and oriented to provide high flexibility and durability for use in vinyl signage or label applications wherein the substrate is printed using a flexographic ink printing process or other suitable dye based or pigmented ink printing processes.

Plasticizer Barrier Layer;

A polyethylene polymer having a density of 0.945 g/cc. The polyethylene was extrusion coated with a recommended melt temperature of 320 C. Corona discharge treatment (CDT) was used prior to the pragmatic sheet being coated with polyethylene at a 2.0 kW setting to promote good adhesion of the melt resin to image element surface. A nip to die distance of 36 cm was utilized and created a neck-in of 12% in order to produce some orientation of the polyethylene during extrusion. Melt extrusion orientation of the polyethylene has been shown to reduce diffusivity of polyethylene and thus improve function of the plasticizer containment layer.

Pressure Sensitive Adhesive;

Removable solvent based acrylic adhesive 25 μm thick.

Carrier sheet;

A two-sided poly coated paper base core lay flat liner. The outermost surface layer of the carrier sheet had a roughness average of 1.98 micrometers and was created by casting the polyethylene against a chilled roller with roughness features with an roughness average of 1.98 micrometers. Opposite the rough polyethylene layer was a layer of UV cured silicone for adhesive release.

Dye Receiving Layer;

Applied to the outermost surface of the pragmatic sheet was a typical polycarbonate, polyester solvent coated thermal dye receiving formulation of approximately 25 μm in thickness that is utilized in thermal dye transfer printing solutions.

The construction of the imaging element of the invention was as follows;

Thermal dye receiving imaging layer
Melt extruded polyethylene plasticizer containment layer
Plasticized vinyl substrate
Acrylic pressure sensitive adhesive
Polyethylene/paper/polyethylene carrier sheet

The resulting imaging element had an overall thickness of 250 micrometers, had a stiffness of 98 mN in the machine direction. The image element prior to the application of the barrier coating prohibited the thermal transfer of dye sublimation to the receiver layer coated on the image element. Severe sticking of the dye coated donor ribbon was sufficient to cause the image element to jam in the web path of the printer. The surface roughness of the backside of the carrier sheet was advantageous to create the necessary coefficient of friction needed for conveyance in the printer, however, the vinyl substrate itself and the plasticizers within caused a breakdown of the dye receiving layer chemistry and effected the sticking of the donor ribbon particularly in areas of higher density in the printed image. Finally, the barrier coating provides dye stability for the transferred densities over time by preventing migration of the dyes from the dye receiver layer due to plasticizer reaching the dye layer and providing a conduit for the dye to migrate into the vinyl substrate layers.

A test image was printed on both the imaging element and an identical imaging element without the polyethylene barrier coating. The printed samples were then measured for initial maximum achievable density following prescribed standardized testing used for thermal dye sublimation transfer printing. The measurements were taken using an X-Rite Model #310 Photographic Densitometer. A set of measured prints for each sample variation were then placed in a 120° F. oven for (5) days to promote accelerated aging which reveals itself in some loss of dye stability within the image. A separate set of identical prints were kept out of conditioning for a visual baseline comparison. The results are listed in Table 1 below.

TABLE 1

| Sample Description | Magenta | Cyan | Yellow |
|---|---|---|---|
| Vinyl laminated film substrate with NO | 2.00 | 1.94 | 2.05 |
| barrier coating (initial reading), control | | | |
| Vinyl laminated film substrate with NO | 1.02 | 1.08 | 0.92 |
| barrier coating (5 day reading), control | | | |
| Vinyl laminated film substrate with PE | 2.01 | 1.95 | 1.89 |
| barrier coating (initial reading), invention | | | |
| Vinyl laminated film substrate with PE | 1.96 | 1.88 | 1.79 |
| barrier coating (5 day reading), invention | | | |
| Prior art thermal dye transfer media used in | 2.25 | 2.21 | 2.28 |
| used in printer (initial reading), control | | | |
| Prior art thermal dye transfer media used in | 2.24 | 2.20 | 2.25 |
| printer (5 day reading), control | | | |

As the results from Table 1 indicate, invention material with a plasticizer containment layer does reduce donor ribbon sticking during the sublimation of thermally transferring the dyes. Further, the plasticizer containment layer significantly reduced the mobility of the thermal dyes compared to the control material as the dyes for the control materials, after 5 days, migrated into the vinyl substrate and pressure sensitive layer. The density of the test targets for yellow, magenta and cyan were all significantly reduced compared to the control materials. Dye migration into the vinyl significantly reduces image quality as dye migration causes both a loss in image density as well as a blurring of the image.

While the plasticizer containment layer utilized in this example was applied as a uniform coating to the surface of the vinyl substrate, the containment layer could have been applied pattern-wise. Pattern-wise application of the plasticizer containment layer allows for controlled, or pattern-wise migration of the plasticizer into an imaging layer, changing selected portions of the image. This selective changing of an image has significant utility for security badges, expiration labels, transient images and image validation technology.

The invention has been described in detail with particular reference to certain preferred embodiments thereof, but it will be understood that variations and modifications can be effected within the spirit and scope of the invention.

1. An imaging member comprising a dye receiving layer, a plasticized polymer layer, and a plasticizer containment layer, wherein the plasticizer is present in an amount greater than 5% of said plasticized polymer layer.

2. The imaging member of claim 1 wherein said plasticized polymer layer comprises polyvinylchloride.

3. The imaging member of claim 1 wherein said plasticizer containment layer comprises at least one member selected from the group consisting essentially of polyesters, polycarbonates, and olefins.

4. The imaging member of claim 1 wherein said plasticizer containment layer comprises a metallic layer.

5. The imaging member of claim 1 wherein said plasticizer containment layer comprises a UV cured polyacrylate.

6. The imaging member of claim 1 wherein said plasticizer containment layer has a plasticizer transmission of less than 0.1 grams per m² per 24 hours.

7. The imaging member of claim 1 wherein said dye receiving layer comprises an ink jet receiving layer.

8. The imaging member of claim 1 wherein said dye receiving layer comprises an thermal dye receiving layer.

9. The imaging member of claim 1 wherein said plasticizer containment layer is applied in a pattern.

10. The imaging member of claim 1 wherein said plasticizer containment layer further comprises a lubricant.

11. The imaging member of claim 10 wherein said lubricant is present in an amount of between 0.5 and 3% of said plasticizer containment layer.

12. The imaging member of claim 1 wherein said plasticizer containment layer has a surface energy of between 32 and 45 dynes per centimeter squared.

13. The imaging member of claim 1 further comprising a pressure sensitive adhesive and carrier sheet wherein the pressure sensitive adhesive is adjacent said plasticized polymer layer.

14. A containment donor element comprising in order a plasticizer containment layer, a dye receiving layer, an oriented polymer sheet, and a lubricant layer.

15. The containment donor element of claim 14 wherein said oriented polymer sheet has a thickness of between 6 and 25 micrometers.

16. The containment donor element of claim 14 wherein said dye receiving layer comprises a cross linked copolymer of polyester and polyurethane.

17. A patterned element comprising in order a low birefringent polymer, a patterned plasticizer containment layer and transparent polymer layer.

18. The patterned element of claim 17 wherein the low birefringent polymer comprises cellulose triacetate and a plasticizer.

19. The patterned element of claim 17 wherein the transparent polymer layer comprises oriented polyvinyl acetate.

20. A method of imaging comprising providing an imaging member comprising a dye receiving layer, a plasticized polymer layer, and a plasticizer containment layer, wherein the plasticizer is present in an amount greater than 5% of said plasticized polymer layer bringing said imaging member into contact with at least one thermal transfer head to transfer at least one dye image to said imaging member.

21. A method of imaging comprising providing a plasticized polymer layer, bringing into contact with said plasticized polymer layer, a containment donor element comprising in order a plasticizer containment layer, a dye receiving layer, an oriented polymer sheet, and a lubricant layer, simultaneously transferring to said plasticized polymer layer the plasticized containment layer and dye receiving layer from said containment donor element to form a dye receiving element.

22. The method of imaging of claim 21 wherein said plasticized polymer layer bearing said plasticized containment layer and dye receiving layer is immediately brought in contact with a thermal transfer head to transfer at least one dye image to said dye receiving layer.
